(19) United States
(12) Patent Application Publication
(10) Pub. No.: US 2026/0064058 A1
(43) Pub. Date: Mar. 5, 2026

(54) FIXING DEVICE AND IMAGE FORMING APPARATUS

(71) Applicant: CANON KABUSHIKI KAISHA, Tokyo (JP)

(72) Inventors: MOTOYASU MURAMATSU, Shizuoka (JP); NAOYUKI MAEDA, Shizuoka (JP)

(21) Appl. No.: 19/252,081

(22) Filed: Jun. 27, 2025

(30) Foreign Application Priority Data
Aug. 30, 2024 (JP) 2024-148998

(51) Int. Cl. G03G 15/20

(52) U.S. Cl. CPC G03G 15/206; G03G 15/2028; G03G 15/2064; G03G 2215/2035; G03G 2215/2051

(57) ABSTRACT

A fixing device includes a rotatable member, a heating member in contact with an inner peripheral surface of the rotatable member; a pressing member and a metallic frame. The pressing roller includes a core metal and a rubber layer covering the core metal and forms a nip with the rotatable member. The metallic frame holds the pressing member and includes inlet and outlet portions provided with openings through which the recording material is conveyed to the nip and the recording material is conveyed from the nip to an outside. In a region other than the inlet and outlet portions, the frame is provided with an opening portion of which a length in a rotational axis direction of the pressing roller is longer than a length of the rubber layer in the rotational axis direction.

### BACKGROUND

### Field of Technology

The present invention relates to a fixing device, which is used in an image forming apparatus employing electrophotographic or electrostatic recording type such as a copy machine, a printer and a facsimile machine, for heating and fixing an unfixed toner image on a recording material and an image forming apparatus which is equipped with the fixing device.

### Description of the Related Art

Conventionally, as a fixing device equipped to a copy machine and a printer of electrophotographic type, those of a film heating type are known (Japanese Patent Application Laid-Open No. 2012-013780). The fixing device of the film heating type includes a cylindrical film, a heater in contact with an inner peripheral surface of the film, and a pressing roller which forms a nip portion with the heater via the film. Examples of the heater include a planer heat generating heater in which a planer heat generating member is provided on a ceramic substrate, and the heater is held by a resin guide member. In addition, the guide member is reinforced by a metallic reinforcing member. A through hole is provided at a part in a longitudinal direction of the guide member, and a temperature detecting element provided in a space between the guide member and the reinforcing member detects a temperature of the heater via the through hole of the guide member. The heater is controlled according to the detected temperature of the temperature detecting element. Similarly, in the space between the guide member and the reinforcing member, a protective element such as a thermostat and a temperature fuse is provided, and the protective element also senses a heat from the heater via another through hole provided in the guide member. The protective element serves to shut off electric power supply to the heater when the heater reaches an excessive temperature. Such a heating unit is brought into contact with a pressing member called the pressing roller at a desired pressure to form the nip portion. By a sheet carrying an unfixed toner image passing through the heated nip portion by driving force of the pressing roller, the unfixed toner image is fixed on the sheet. Generally, these heating unit and the pressing roller are held, so that a frame of the fixing device is not significantly deformed by thermal expansion, thermal deformation and/or pressing force, by a metallic frame and structured as the fixing device.

On the other hand, the heater is heated by flowing AC current through the heat generating member formed on the substrate of the heater. Therefore, it is defined as a safety standard to configure the film in contact with the heater and the pressing roller forming the nip portion with the heater via the film to keep a desired distance from a safety earth.

However, for the fixing device in recent years, those of fast, compact and low cost are requested. Therefore, it is necessary to increase a diameter of the pressing roller for higher speed and to downsize a device frame for downsizing. In those cases, when a distance between the device frame and the pressing roller is simply narrowed, the pressing roller and the device frame becomes closer than a distance required for insulation which is required in the safety standard. Therefore, in order to secure the insulation distance between the pressing roller and the device frame, it is necessary to secure a creepage distance, and it is necessary to secure the insulation distance, between the pressing roller and the device frame, by providing an insulating resin member and/or a sheet member. However, with this method, there is a problem that cost is increased.

### SUMMARY

The present invention is conceived under such a background, and an object of the present invention is to provide an inexpensive and space-saving fixing device while meeting a safety standard.

According to an aspect of the present invention, there is provided a fixing device for fixing a toner image formed on a recording material on the recording material, the fixing device comprising: a heating unit including a rotatable member which is cylindrical and flexible and a heating member in contact with an inner peripheral surface of the rotatable member; a pressing roller including a core metal and a rubber layer covering the core metal and configured to contact an outer peripheral surface of the rotatable member, the pressing roller forming a nip portion with the rotatable member by sandwiching the rotatable member with the heating member; and a metallic frame configured to hold the pressing roller, the frame including an inlet portion provided with an opening through which the recording material is conveyed to the nip portion and an outlet portion provided with an opening through which the recording material is conveyed from the nip portion to an outside, wherein in a region other than the inlet portion and the outlet portion, the frame is provided with an opening portion of which a length in a rotational axis direction of the pressing roller is longer than a length of the rubber layer in the rotational axis direction.

Further features of the present invention will become apparent from the following description of exemplary embodiments with reference to the attached drawings.

### BRIEF DESCRIPTION OF THE DRAWINGS

FIG. 1 is a cross-sectional outline view of a fixing device in an Embodiment 1.

FIG. 2 is an outline view of the fixing device in Embodiments 1 through 3.

FIG. 3, part (a) and part (b), is an outline view of a heater in the Embodiments 1 through 3.

FIG. 4 is a cross-sectional outline view of a fixing device in a Comparative Example.

FIG. 5, part (a) and part (b), is an outline view of the fixing device in the Comparative Example.

FIG. 6 is an outline view of the fixing device in the Embodiment 1.

FIG. 7 is a cross-sectional outline view of the fixing device in the Embodiment 2.

FIG. 8 is an outline view of the fixing device in the Embodiment 2.

FIG. 9 is a cross-sectional outline view of an image forming apparatus in the Embodiment 3.

FIG. 10 is a cross-sectional outline view of the fixing device in the Embodiment 3.

FIG. 11 is an outline view of the fixing device in the Embodiment 3.

### DESCRIPTION OF THE EMBODIMENTS

Hereinafter, Embodiments of the present invention will be described using the drawings Incidentally, the Embodiments below are not intended to limit the invention according to the claims, and it is not necessarily that all of the combinations of characteristics described in the Embodiments are essential to solution of the invention.

### Embodiment 1

Hereinafter, an Embodiment 1 of the present invention will be described.

### <Fixing Device>

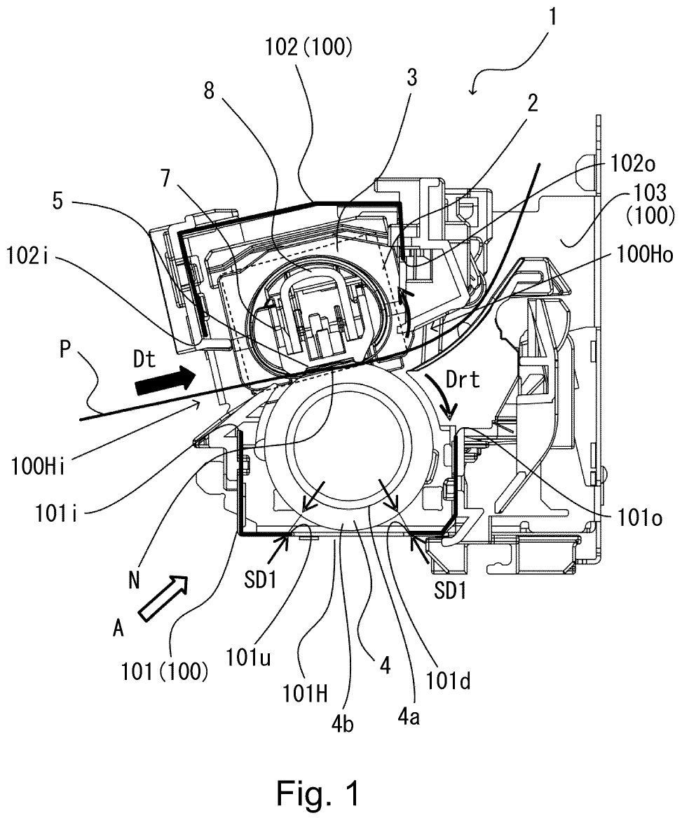

An overall configuration of a fixing device 1 in the Embodiment 1 will be described using FIG. 1 through FIG. 6. FIG. 1 is a cross-sectional outline view of the fixing device 1. The fixing device 1 includes a heating unit 2, which includes a film 3 as a rotatable, cylindrical and flexible rotatable member surrounding a heater 5, which has a heat generating member, inside thereof, and a pressing roller 4 which forms a nip portion N by being pressed against the heating unit 2 by an unshown pressing means. The pressing roller 4 contacts an outer peripheral surface of the film 3. By nipping and conveying a recording material P in the nip portion N, an unfixed toner image (not shown) on the recording material P can be heated and fixed thereon. The heating unit 2 and the pressing roller 4 are encased in a device frame 100.

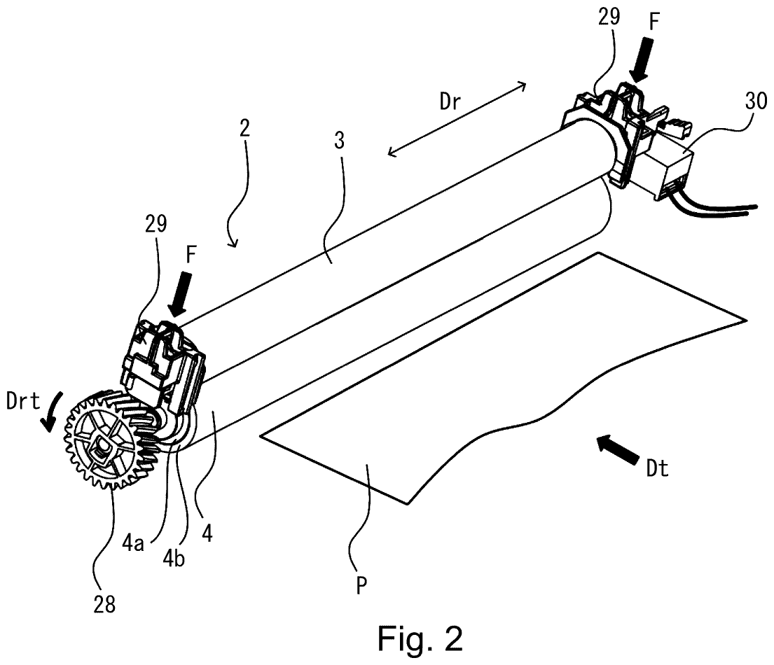

FIG. 2 is an outline view of the heating unit 2 and the pressing roller 4 of the fixing device 1. Here, a direction perpendicular to a conveyance direction Dt of the recording material P, in other words, a rotational axis direction or a longitudinal direction of the film 3 and the pressing roller 4 is defined as Dr. The heating unit 2 and the pressing roller 4 are supported at both ends thereof by the device frame 100 of the fixing device 1 (see FIG. 1), and the pressing roller 4 is configured to be rotationally driven in a rotational direction Drt by driving power being transmitted from an unshown driving source to a drive gear 28. The pressing roller 4 includes a core metal 4a made of iron, etc., and a rubber layer 4b covering a periphery of the core metal 4a.

The film 3, which makes pressure contact with the pressing roller 4, is configured to be rotated driven by the pressing roller 4. Inside the film 3, the heater 5 as a heating member is provided, and an inner peripheral surface of the film 3 and the heater 5 are slidably in contact with each other, and both ends thereof are held by flanges 29. Incidentally, it may be a configuration in which the heating member includes the heater 5 and a sliding contact member (a metallic plate, etc.), and the sliding contact member is in contact with the inner peripheral surface of the film 3.

Between the heater 5 and the film 3, grease is applied in order to improve sliding property. The heater 5 is configured so as to generate heat by an electric power being supplied by an unshown electric power supply means from a connector 30, which is an electrical contact portion. Inside the film 3, the heater 5 is held by a heater holder 7 (FIG. 1). In addition, the nip portion N formed by the film 3 and the pressing roller 4 preferably has a uniform width in the rotational axis direction (Dr) of the film 3. Therefore, to the heater holder 7, in order to improve a strength against the press contact force, at a position shown in FIG. 1, a metallic reinforcing member 8 (FIG. 1) is attached. The reinforcing member 8 receives, via the flanges 29 provided at both ends in a longitudinal direction of the reinforcing member 8, pressing force F from the unshown pressing means. The heating unit 2 is attached to the device frame 100 by inserting the flange 29 into the device frame 100.

### <Heater>

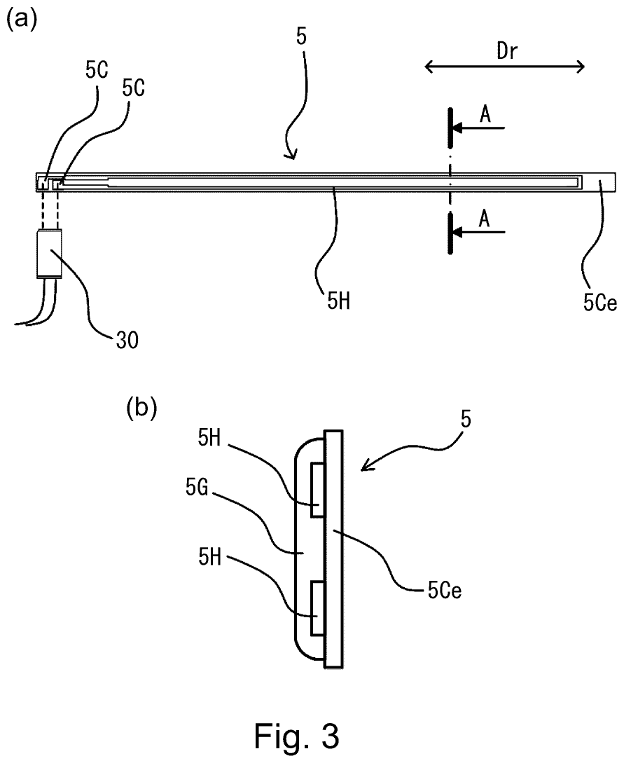

Next, using FIG. 3, a configuration of the heater 5 will be described. Part (a) of FIG. 3 is a plan view of the configuration of the heater 5, and part (b) of FIG. 3 is an A-A cross-sectional view of part (a) of FIG. 3. A planer heat generating member 5H is disposed on a ceramic heater base material 5Ce, and a glass layer 5G covers the heat generating member 5H. At an end portion of the heater 5, a heater contact portion 5C, which is a contact portion with the connector 30, is provided, and by supplying AC current to the heat generating member 5H via the connector 30, the heat generating member 5H is caused to generate heat. Incidentally, the heater contact portion 5C is not covered by the glass layer 5G.

The heating unit 2 includes an unshown temperature detecting means which detects a temperature of the heater 5, and during conveyance of the recording material P, by performing detection of the temperature, the supply of the AC current is controlled, and the heater 5 is controlled at a desired temperature. In this manner, since the AC current flows through the heat generating member 5H of the heater 5, basic insulation is provided by the glass layer 5G, and the film 3 in contact with the heater 5 and the pressing roller 4 in contact with the film 3 are at basic insulation potential. Therefore, it is necessary for the metallic device frame 100 (frame), which also serves as a safety earth, with respect to the film 3 and the pressing roller 4, according to the safety standard, to keep a clearance (space distance) and a creepage distance required to ensure supplementary insulation from the components at the basic insulation potential. In the Embodiment 1, between the pressing roller 4 and the device frame 100, 2.3 mm in terms of the clearance and 2.5 mm in terms of the creepage distance in the supplementary insulation distance, which are defined by values in the safety standard IEC62368, are secured.

### <Description for the Device Frame and a Problem>

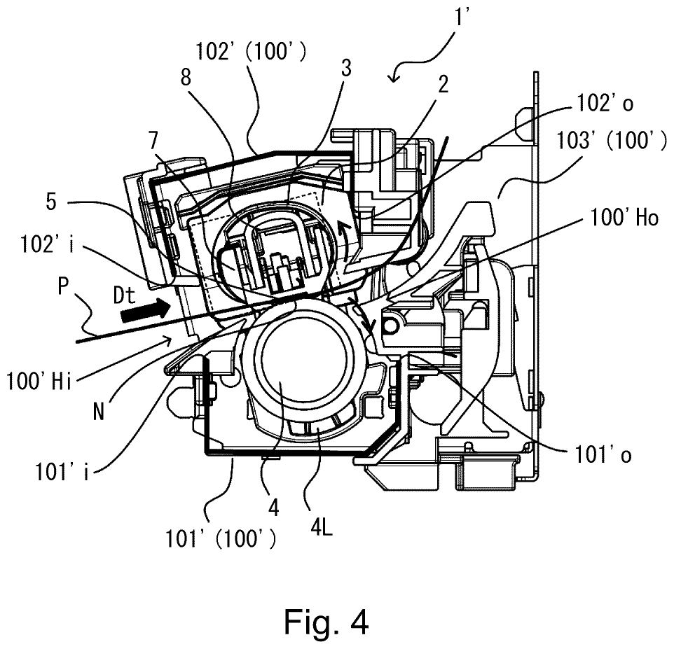

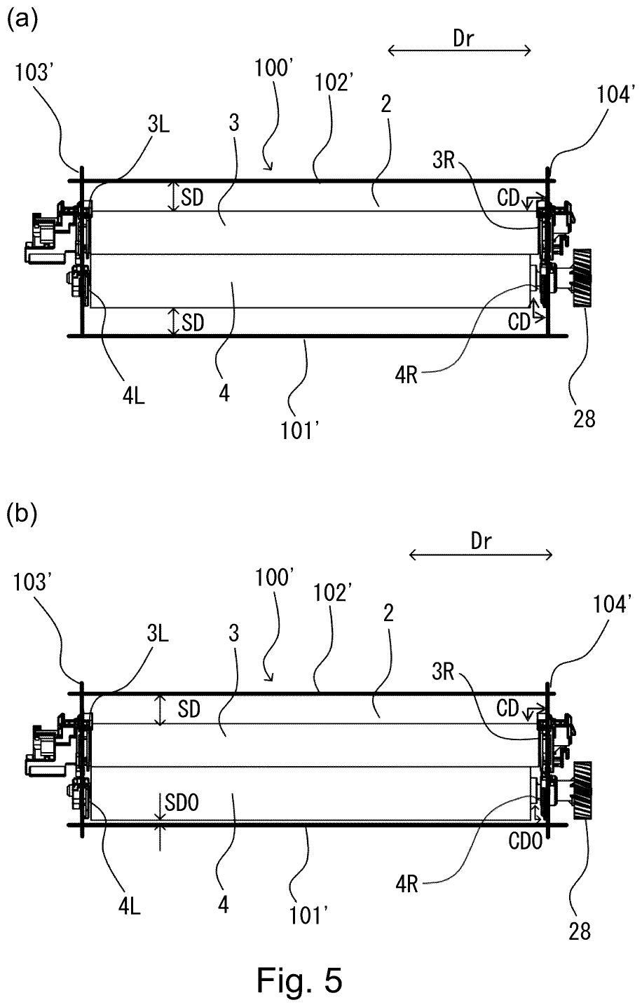

FIG. 4 shows a cross-sectional outline view of a fixing device 1′ in a Comparative Example, and part (a) of FIG. 5 is an outline view showing a relationship among a device frame 100′ in the Comparative Example, the heating unit 2 and the pressing roller 4 in the longitudinal direction Dr. Here, one end portion in the longitudinal direction Dr is defined as left and the other end portion as right. In addition, a surface on a left side of the metallic device frame 100′ is, hereinafter, referred to as a device frame 103′ and a right side thereof, hereinafter, as a device frame 104′. A surface (first surface) of the device frame 100′ extending in the longitudinal direction Dr on the pressing roller 4 side (downside) is referred to as a device frame 101′, and a surface (second surface) of the device frame 100′ extending in the longitudinal direction Dr on the film 3 side (upper side) is referred to as a device frame 102′. The device frame 101′ is a surface opposing the pressing roller 4, and the device frame 102′ is a surface opposing the film 3.

As shown in FIG. 4, as viewed in the rotational axis direction (Dr) of the film 3 and the pressing roller 4, the device frame 101′ has a U-shape in a cross-section thereof, and an end portion on an upstream side in the conveyance direction Dt is referred to as an end portion 101′i and an end portion on a downstream side therein is referred to as an end portion 101′o. Similarly, the device frame 102′ has a U-shape in a cross-section thereof, and an end portion on the upstream side in the conveyance direction Dt is referred to as an end portion 102′i and an end portion on the downstream side therein is referred to as an end portion 102′o. The end portion 101′i of the device frame 101′ and the end portion 102′i of the device frame 102′ are separated by a predetermined distance as shown in FIG. 4, and form an opening (hereinafter, referred to as an inlet portion 100′Hi) so that a leading end of the recording material P is guided to the nip portion N of the fixing device 1. The end portion 101′o of the device frame 101′ and the end portion 102′o of the device frame 102′ are also separated by a predetermined distance, and form an opening (hereinafter, referred to as an outlet portion 100′Ho) so that the leading end of the recording material P is guided from the nip portion N of the fixing device 1 to an outside of the fixing device 1. Incidentally, it is not necessary for the device frame 101′ and the device frame 102′ to have the U-shape in the cross-section thereof, but sufficient to have such a shape that surrounds the film 3 and the pressing roller 4, respectively, and sufficient that the inlet portion 100′Hi and the outlet portion 100′Ho, which are an inlet and an outlet for the recording material P, are formed.

The device frame 103′ and the device frame 104′ are fastened to the device frame 101′ and the device frame 102′, respectively, by unshown fastening means and fixed thereto. As a result, as shown in part (a) of FIG. 5, a cross-section of the device frame 100′ in a direction perpendicular to the conveyance direction Dt becomes a rectangular shape. The heating unit 2 and the pressing roller 4 are supported at both ends thereof by the device frame 103′ and the device frame 104′, respectively.

### <A Clearance and a Creepage Distance>

In such a structure, the film 3 and the pressing roller 4, which are at the basic insulation potential, are disposed separated, from the device frame 100′, by a clearance SD of 2.3 mm or more and by a creepage distance CD of 2.5 mm or more. The end portions of the film 3 and the pressing roller 4 secure, with insulating resin members 3L, 3R, 4L and 4R, the creepage distance CD, which is the supplementary insulation distance or more, respectively. Here, on the left end side of the film 3, the creepage distance CD is a distance from a surface of the film 3 to the device frame 103′ via the resin member 3L. On the right end side of the film 3, the creepage distance CD is a distance from the surface of the film 3 to the device frame 104′ via the resin member 3R. The creepage distance CD between the film 3 and the device frame 103′ (104′) is set so that a smaller value of the creepage distance either on the left or the right meets the safety standard. On the left end side of the pressing roller 4, the creepage distance CD is a distance from the core metal 4a of the pressing roller 4 to the device frame 103′ via the resin member 4L. On the right end side of the pressing roller 4, the creepage distance CD is a distance from the core metal 4a of the pressing roller 4 to the device frame 104′ via the resin member 4R. The creepage distance CD of the pressing roller 4 is set so that a smaller value of the creepage distance either on the left or the right meets the safety standard.

On the other hand, the clearance SD between the film 3 and the device frame 102′ and the clearance SD between the pressing roller 4 and the device frame 101′ are also both 2.3 mm or more so as to secure the supplementary insulation distance. In other words, it is configured so that, in the clearance SD as well, it is separated by the insulation distance, which is determined by the safety standard, or more (a predetermined distance or more). Here, the clearance SD is a distance between the surface of the film 3 and the device frame 102′. The clearance SD is a distance between a surface of the pressing roller 4 and the device frame 101′.

In recent years, however, downsizing, higher speed and lower cost of an image forming apparatus have been requested. Therefore, it is necessary to downsize a cross-section of the fixing device 1, or to downsize the device frame 100′ even while a diameter of the pressing roller 4 gets larger. Therefore, as shown in part (b) of FIG. 5, when a clearance SD0 between the pressing roller 4 and the device frame 101′ is simply narrowed, the clearance SD0 becomes less than 2.3 mm (SD0<2.3 mm). Therefore, in order to secure the supplementary insulation distance, it is necessary to secure a creepage distance CD0 of 2.5 mm or more, and it is necessary to secure the supplementary insulation distance, between the pressing roller 4 and the device frame 101′, by providing a further insulating resin member and/or a sheet member. However, with this method, while downsizing can be realized, there is a problem that cost is increased. The same problem arises when the clearance on the film 3 side is narrowed.

Incidentally, in part (a) of FIG. 5, the clearance SD is illustrated in an area in the longitudinal direction Dr of the pressing roller 4 excluding both left and right end portions. The pressing roller 4 includes the core metal 4a and the rubber layer 4b as described above, and the core metal 4a is not exposed in the area excluding both left and right end portions. Therefore, the surface of the pressing roller 4 is the rubber layer 4b (in a case in which a fluorine resin layer is provided on the rubber layer 4b, the fluorine resin layer), and it is sufficient to consider a distance between the rubber layer 4b (fluorine resin layer) and the device frame 101′ as the clearance SD. However, at both left and right end portions of the pressing roller 4, since the core metal portion 4a is exposed (see FIG. 2), it is necessary to consider both the core metal 4a and the rubber layer 4b. In other words, it is necessary to consider both a clearance between the core metal 4a and the device frame 101′ and the clearance between the rubber layer 4b and the device frame 101′, and it is necessary for a smallest value of a plurality of the clearances to meet the safety standard. Hereafter, when referred as “the clearance between the pressing roller 4 and the device frame 101′”, it includes not only the clearance between the rubber layer 4b and the device frame 101′ but also the clearance between the core metal 4a and the device frame 101′.

### <Device Frame Opening Portion>

In the Embodiment 1 shown in FIG. 1, it is a configuration in which an opening portion is provided in a region other than the inlet portion 100Hi and the outlet portion 100Ho (other than the inlet portion and the outlet portion). For example, in the Embodiment 1, an opening portion 101H is provided at an opposing portion of the device frame 101 to the pressing roller 4 in FIG. 1. Incidentally, a configuration of the device frame 100 in the Embodiment 1 other than the opening portion 101H is the same as that of the device frame 100′, and reference numerals in FIG. 4 and FIG. 5 without “‘” is attached thereto and description thereof will be omitted.

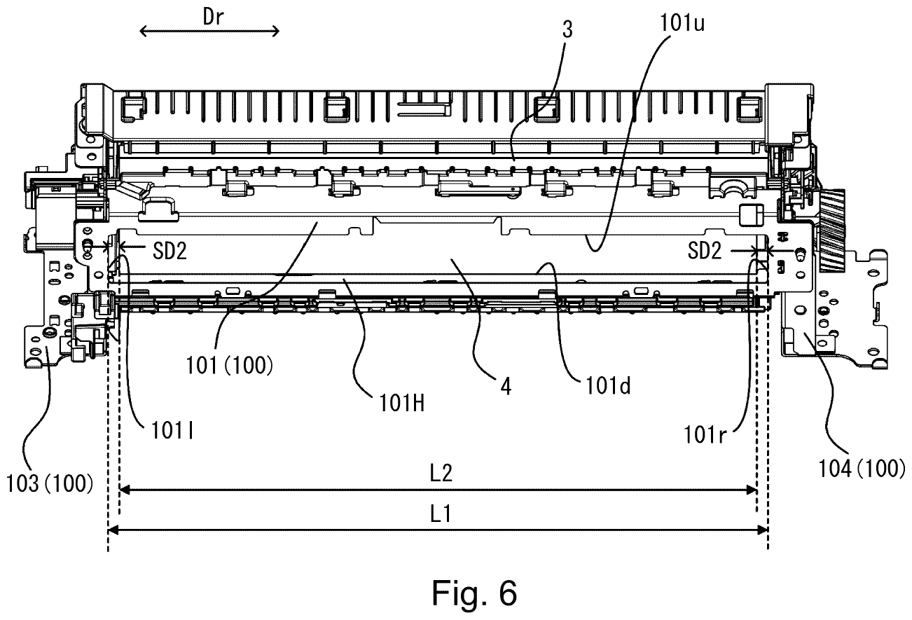

FIG. 6 is an outline view as viewed in a direction of a hollow arrow A of FIG. 1. Here, as shown in FIG. 1, of edge portions of the device frame 101 which form the opening portion 101H, an edge portion on the upstream side in the conveyance direction Dt of the recording material P is referred to as an edge 101u, and an edge portion on the downstream side therein is referred to as an edge 101d. In addition, of the edge portions of the device frame 101 which form the opening portion 101H, one end portion in the longitudinal direction Dr (end portion on the left side) is referred to as an edge 1011 and the other end portion (end portion on the right side) is referred to as an edge 101r.

Clearances SD1 shown in FIG. 1 are a distance between the surface of the pressing roller 4 and the edge 101u of the opening portion 101H and a distance between the surface of the pressing roller 4 and the edge 101d of the opening portion 101H. In addition, clearances SD2 shown in FIG. 6 indicate a distance between one end portion in the longitudinal direction Dr of the pressing roller 4 (end portion on the left side) and the edge 1011 of the opening portion 101H and a distance between the other end portion therein of the pressing roller 4 (end portion on the right side) and the edge 101r of the opening portion 101H. By setting the opening portion 101H at a position at which the clearances SD1 and SD2 are not less than 2.3 mm, it becomes possible to secure the supplementary insulation distance. In this manner, in the Embodiment 1, it is configured that the opening portion 101H is provided at the portion in the device frame 101 opposing the pressing roller 4 so that SD1≥2.3 mm and SD2≥2.3 mm. As shown in FIG. 6, the opening portion 101H is formed so that a length L1 thereof in the longitudinal direction Dr is longer than a length of the pressing roller 4 in the longitudinal direction Dr, more specifically, a length L2 of the rubber layer 4b in the longitudinal direction Dr (L1>L2). In the Embodiment 1, the clearance SD1 and the clearance SD2 are set to 3.5 mm with taking variation in components into consideration.

### Modified Example 1

In the Embodiment described above, the opening portion 101H is provided to the device frame 101 opposing the pressing roller 4 to reduce an overall area of the fixing device 1 in the cross-section thereof perpendicular to the rotational axis direction (Dr) while meeting the safety standard, however, it is not limited thereto.

For example, an opening portion may be provided to the device frame 102 opposing the film 3. In this case, it is sufficient to provide the opening portion so that the clearance between the film 3 and an edge of the opening portion provided to the device frame 102 is not less than 2.3 mm. Furthermore, the opening portions may be provided to both the device frame 101 and the device frame 102.

### Modified Example 2

In FIG. 1 described above, as viewed in the rotational axis direction (Dr) of the fixing device 1, it is in a state in which a surface of the pressing roller 4 is not projected from the opening portion 101H to the outside of the fixing device 1, however, the pressing roller 4 may be partially projected from the opening portion 101H to the outside of the fixing device 1. By this, as viewed in the rotational axis direction of the fixing device 1, it becomes possible to make an area enclosed by the device frame 100 smaller, and make the diameter of the pressing roller 4 even larger for higher speed.

Incidentally, upon providing the opening portion to the device frame 102 on the film 3 side, the film 3 may be partially projected from this opening portion to the outside of the fixing device 1. Furthermore, upon providing the opening portions to both the device frame 101 and the device frame 102, both the pressing roller 4 and the film 3 may be partially projected from the opening portions, respectively. In this case also, as the cross section is viewed from the rotational axis direction (Dr) of the fixing device 1, it becomes possible to make the area enclosed by the device frame 100 smaller.

As described above, according to the configuration in the Embodiment 1, for downsizing of the fixing device 1, it becomes possible to make the cross-section of the fixing device 1 smaller. In addition, even upon making the diameter of the pressing roller 4 larger along with the increase in speed of the fixing device 1, it becomes possible to make the cross-sectional area of the fixing device 1 smaller, and to provide the inexpensive and compact fixing device.

As described above, according to the Embodiment 1, it becomes possible to provide the inexpensive and space-saving fixing device while meeting the safety standard.

### Embodiment 2

A configuration in an Embodiment 2 will be described. Incidentally, in the Embodiment 2, to the same configurations as those described in the Embodiment 1 above, the same reference numerals are attached. In addition, description for the configurations and functions thereof which are the same as those in the Embodiment 1 will be omitted, and only characteristic portions in the Embodiment 2 will be described.

### <Configuration of a Device Frame>

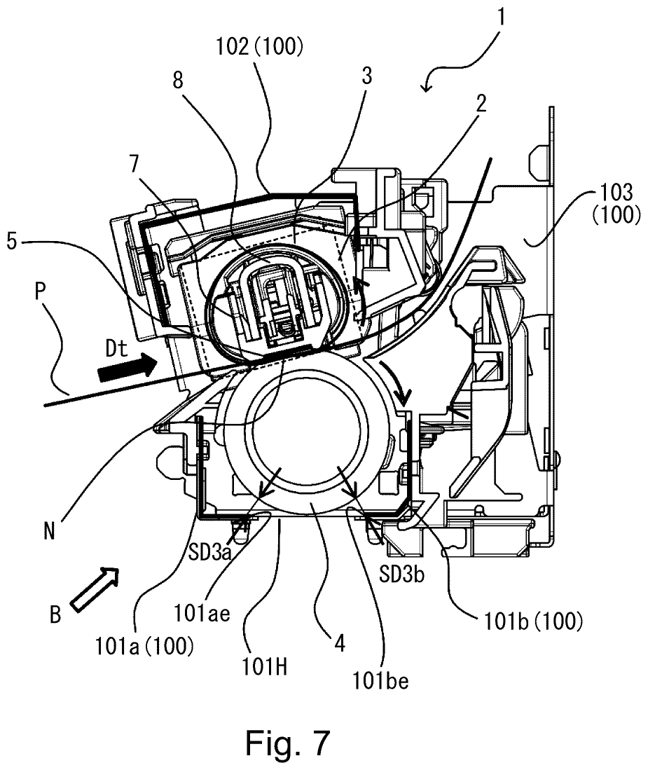

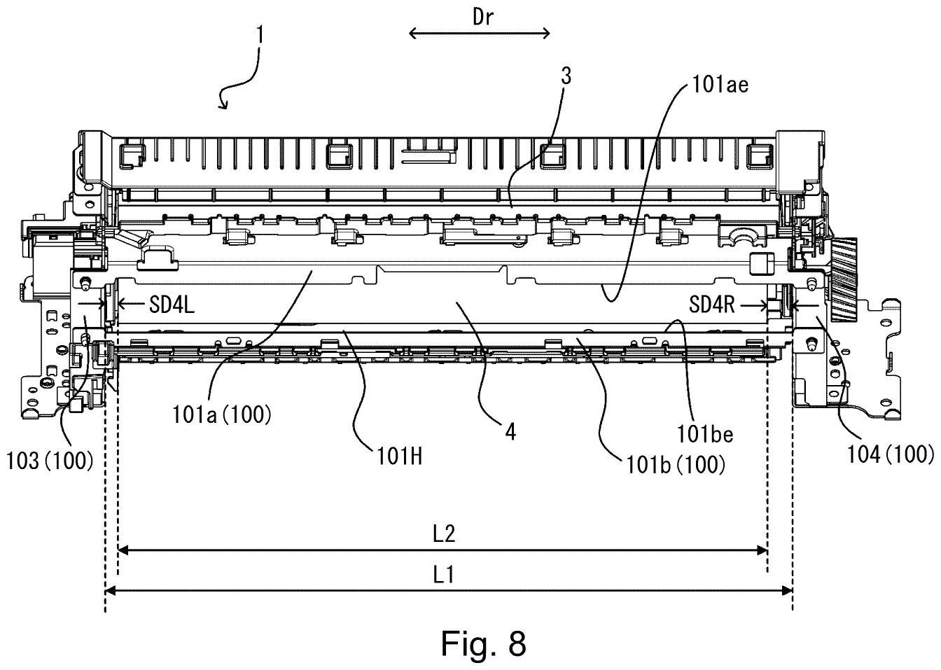

FIG. 7 is a cross-sectional outline view of a fixing device 1 in the Embodiment 2, and FIG. 8 is a perspective outline view as viewed in a direction of an arrow B in FIG. 7. While in the Embodiment 1, it is the configuration in which the opening portion 101H is provided to the device frame 101, in the Embodiment 2, the device frame 101 is divided into two members, and the opening portion is formed by the two members taking a distance from each other. Here, in the device frame 101, a member on the upstream side in the conveyance direction D of the recording material P is referred to as a device frame 101a (first surface) and a member on the downstream side therein is referred to as a device frame 101b (second surface). In addition, in the device frame 101a, an end portion opposing the device frame 101b is referred to as an edge 101ae, and in the device frame 101b, an end portion opposing the device frame 101a is referred to as an edge 101be.

As shown in FIG. 8, the device frame 101 is constituted to be separated into the device frame 101a and the device frame 101b, and each is fastened to the device frame 103 and the device frame 104. As a result, an opening portion 101H is formed in an opposing portion to the pressing roller 4. In other words, a frame shape is formed by the device frames 101a and 101b, the device frame 103 and the device frame 104.

A clearance SD3a and a clearance SD3b shown in FIG. 7 are distances from the surface of the pressing roller 4 to the edges of the opening portion 101H. In more detail, the clearance SD3a is a distance between the surface of the pressing roller 4 and the edge 101ae of the device frame 101a. The clearance SD3b is a distance between the surface of the pressing roller 4 and the edge 101be of the device frame 101b. In addition, a clearance SD4L shown in FIG. 8 is a distance between a left end portion in the longitudinal direction Dr of the pressing roller 4 and the device frame 103. In addition, a clearance SD4R is a distance between a right end portion in the longitudinal direction Dr of the pressing roller 4 and the device frame 104. L1 and L2 are the same as in the Embodiment 1.

By setting the opening portion 101H at a position at which the clearances SD3a and SD3b, and the clearances SD4L and SD4R are not less than 2.3 mm, it becomes possible to secure the supplementary insulation distance. In this manner, in the Embodiment 2, it is configured that the opening portion 101H is provided at the portion opposing the pressing roller 4 so that SD3a≥2.3 mm, SD3b≥2.3 mm, SD4L≥2.3 mm and SD4R≥2.3 mm. In the Embodiment 2, the clearances SD3a and SD3b and the clearances SD4L and SD4R are set to 3.5 mm with taking variation in components into consideration.

Incidentally, in the case in which the opening portion is provided to the device frame 102 on the film 3 side, the opening portion may be formed by dividing the device frame 102 into two members (a first surface and a second surface). In addition, upon providing the opening portions to both the device frame 101 and the device frame 102, each of both device frames may be divided into two members (a first surface and a second surface) (a third surface and a fourth surface) to form respective opening portions. In addition, the opening portion may be formed by dividing only one of the device frames into two members. Furthermore, the film 3 and/or the pressing roller 4 may be partially projected from the opening portion formed by the two members to the outside the fixing device 1.

As described above, according to the configuration in the Embodiment 2, for downsizing of the fixing device 1, it becomes possible to make the cross-sectional area of the fixing device 1 smaller. In addition, even upon making the diameter of the pressing roller 4 larger along with the increase in speed of the fixing device 1, it becomes possible to make the cross-sectional area of the fixing device 1 smaller, and to provide the inexpensive and compact fixing device. Incidentally, in the Embodiment 2, it is constituted by the metallic device frames 101a and 101b, however, only one of the device frames 101a and 101b may be made of metal, and the other may be made of resin.

As described above, according to the Embodiment 2, it becomes possible to provide the inexpensive and space-saving fixing device while meeting the safety standard.

### Embodiment 3

A configuration in an Embodiment 3 will be described. Incidentally, in the Embodiment 3, to the same configurations as those described in the Embodiment 1 and the Embodiment 2 above, the same reference numerals are attached. In addition, description for the configurations and functions thereof which are the same as those in the Embodiment 1 and the Embodiment 2 will be omitted, and only characteristic portions in the Embodiment 3 will be described.

### <Image Forming Apparatus>

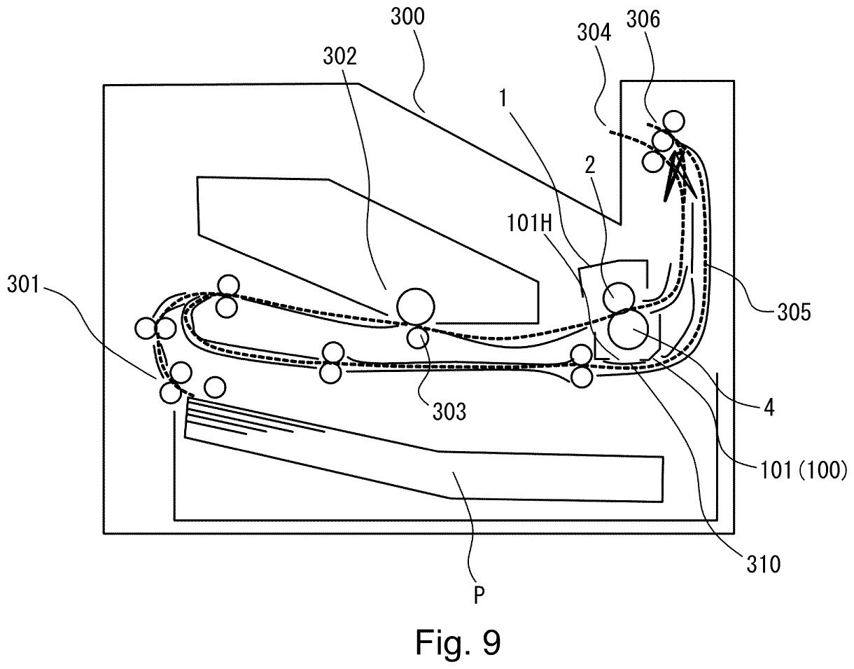

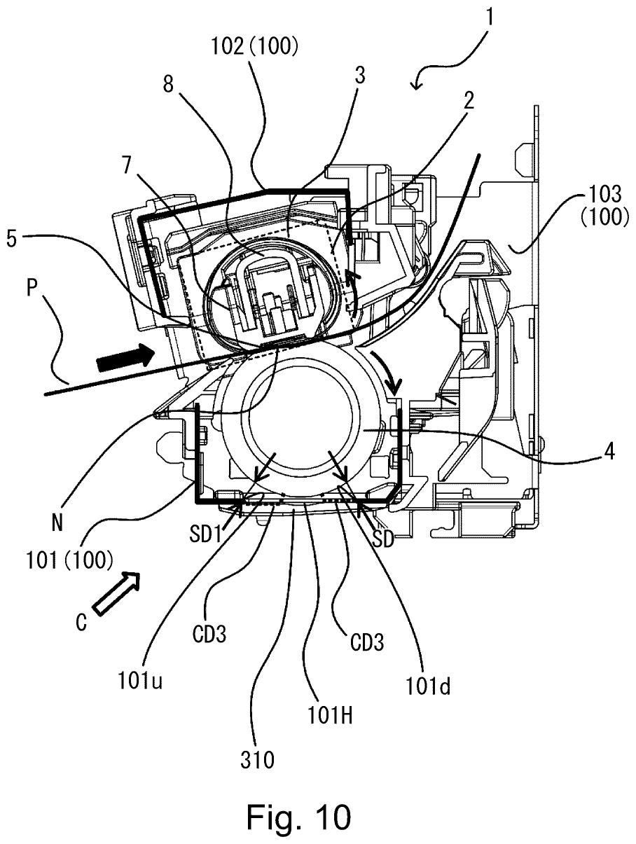

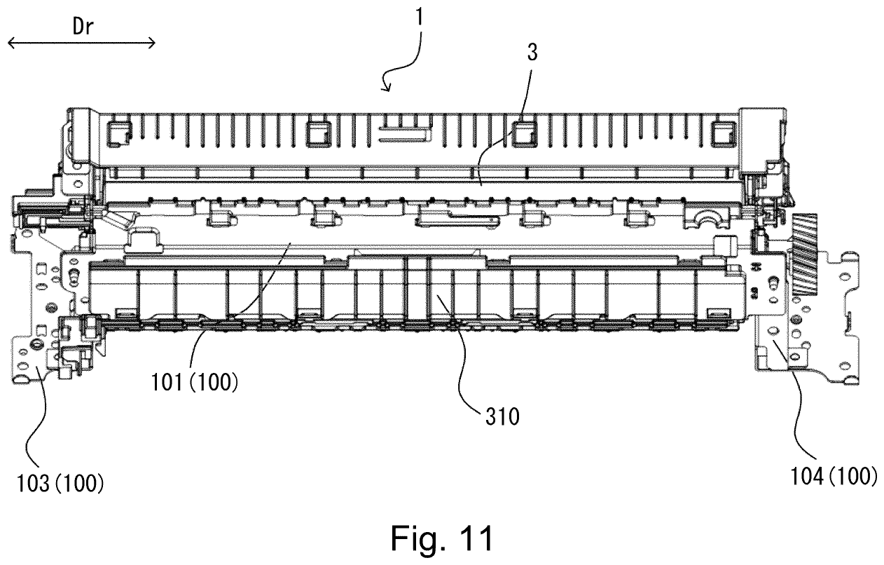

FIG. 9 is a cross-sectional outline view of an image forming apparatus 300 using a fixing device 1. FIG. 10 is a cross-sectional outline view of the fixing device 1 in the Embodiment 3, and FIG. 11 is a perspective outline view as viewed in a direction of an arrow C in FIG. 10. An outline of the image forming apparatus 300 provided with the fixing device 1 will be described using FIG. 9. To the recording material P fed from a sheet feeding portion 301, a toner image formed by an image forming portion 302 as an image forming means is transferred in a transfer portion 303. Thereafter, the unfixed toner image is fixed on the recording material P by passing through the fixing device 1, and the recording material P is discharged to a discharging portion 304.

In a case of a double-side printing, after a switchback in a reversing portion 306, the recording material P passes through a double-side conveyance path 305, passes through the transfer portion 303 and the fixing device 1 again, and is discharged to the discharging portion 304.

Here, as shown in FIG. 9, the recording material P conveyed through the double-side conveyance path 305 passes through below the fixing device 1 and is conveyed again to the transfer portion 303. More specifically, the recording material P conveyed through the double-side conveyance path 305 passes through below the device frame 101, in other words, below the opening portion 101H.

In the image forming apparatus 300 in this manner, in the case in which there is the opening portion 101H in the device frame 101 of the fixing device 1, there is a risk that a user may touch the pressing roller 4 which becomes hot, or a jam may occur due to the recording material P during double-side conveyance being caught in the opening portion 101H. Therefore, in the Embodiment 3, the opening portion 101H is covered by a resin cover member 310 which is shown in FIG. 9 and FIG. 10. The cover member 310 covers the opening portion 101H and protects the pressing roller 4, and also functions as a conveyance guide for the recording material P being conveyed. In more detail, the cover member 310 covers the opening portion 101H on a surface opposing the pressing roller 4 and guides the recording material P on a surface on the opposite side of the surface opposing the pressing roller 4. In this case, it is configured so that a creepage distance CD3 to the device frame 101 via the cover member 310 is 2.5 mm or more. Here, the creepage distances CD3 in FIG. 10 are a distance from the surface of the pressing roller 4 to the edge 101u via the cover member 310 and a distance from the surface of the pressing roller 4 to the edge 101d via the cover member 310. The creepage distances CD3 are shown as ditted lines. Incidentally, the cover member 310 may also be applicable to the Embodiment 2.

Incidentally, in the case in which the opening portion is provided to the device frame 102 on the film 3 side, this opening may be covered by the cover member. In addition, upon providing the opening portions to both the device frame 101 and the device frame 102, both opening portions may be covered by the cover members.

Furthermore, the cover member 310 is not limited to a shape which covers a whole area of the opening portion 101H. In a periphery to which the cover member 310 is attached, various components may be present. In such cases, one or more openings may be provided in the cover member 310 to avoid these components, and the cover member 310 may not cover the whole area of the opening portion 101H, in other words, the cover member 310 may cover a partial area of the opening portion 101H. In other words, it is sufficient for the opening portion 101H to be covered by the cover member 310 to an extent that it is possible to prevent human fingers or the recording material P from entering the opening portion 101H.

As described above, according to the configuration in the Embodiment 3, for downsizing of the fixing device 1, it becomes possible to make the cross-sectional area of the fixing device 1 smaller. In addition, even upon making the diameter of the pressing roller 4 larger along with the increase in speed of the fixing device 1, it becomes possible to make the cross-sectional area of the fixing device 1 smaller. And even in the configuration in which the fixing device 1 is provided at the position where a user may touch the fixing device 1 in the image forming apparatus 300 and becomes a part of the conveyance portion for the recording material P, it becomes possible to provide the inexpensive and compact fixing device. Incidentally, the clearance of 2.3 mm and the creepage distance of 2.5 mm for the supplementary insulation distance are in accordance with the values in the safety standard IEC62368, and upon practicing the present invention, the clearance and the creepage distance conform values in a latest standard.

As described above, according to the Embodiment 3, it becomes possible to provide the inexpensive and space-saving fixing device while meeting the safety standard.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-148998 filed on Aug. 30, 2024, which is hereby incorporated by reference herein in its entirety.

What is claimed is:

1. A fixing device for fixing a toner image formed on a recording material on the recording material, the fixing device comprising:
a heating unit including a rotatable member which is cylindrical and flexible and a heating member in contact with an inner peripheral surface of the rotatable member;
a pressing roller including a core metal and a rubber layer covering the core metal and configured to contact an outer peripheral surface of the rotatable member, the pressing roller forming a nip portion with the rotatable member by sandwiching the rotatable member with the heating member; and
a metallic frame configured to hold the pressing roller, the frame including an inlet portion provided with an opening through which the recording material is conveyed to the nip portion and an outlet portion provided with an opening through which the recording material is conveyed from the nip portion to an outside,
wherein in a region other than the inlet portion and the outlet portion, the frame is provided with an opening portion of which a length in a rotational axis direction of the pressing roller is longer than a length of the rubber layer in the rotational axis direction.

2. The fixing device according to claim 1, wherein the frame includes a surface opposing the pressing roller, and
wherein the opening portion is provided in the surface.

3. The fixing device according to claim 1, wherein the frame includes a first surface opposing the pressing roller and a second surface opposing the pressing roller and different from the first surface, and
wherein as viewed in the rotational axis direction, the opening portion is formed by the first surface and the second surface being separated from each other.

4. The fixing device according to claim 2, wherein as viewed in the rotational axis direction, the pressing roller is partially projected from the opening portion to the outside.

5. The fixing device according to claim 1, wherein the frame includes a surface opposing the rotatable member, and
wherein the opening portion is provided in the surface.

6. The fixing device according to claim 1, wherein the frame includes a first surface opposing the rotatable member and a second surface opposing the rotatable member and different from the first surface, and
wherein as viewed in the rotational axis direction, the opening portion is formed by the first surface and the second surface being separated from each other.

7. The fixing device according to claim 5, wherein as viewed in the rotational axis direction, the rotatable member is partially projected from the opening portion to the outside.

8. The fixing device according to claim 1, wherein the frame includes a first surface opposing the pressing roller and a second surface opposing the rotatable member; and
wherein the opening portion is provided in the first surface and the second surface.

9. The fixing device according to claim 1, wherein the frame includes a first surface opposing the pressing roller, a second surface opposing the pressing roller and different from the first surface, a third surface opposing the rotatable member, and a fourth surface opposing the rotatable member and different from the third surface,
wherein as viewed in the rotational axis direction, the opening portion is formed by the first surface and the second surface being separated from each other, and
wherein as viewed in the rotational axis direction, the opening portion is formed by the third surface and the fourth surface being separated from each other.

10. The fixing device according to claim 8, wherein as viewed in the rotational axis direction, the pressing roller is partially projected from the opening portion opposing the pressing roller to the outside, and
wherein as viewed in the rotational axis direction, the rotatable member is partially projected from the opening portion opposing the rotatable member to the outside.

11. The fixing device according to claim 1, wherein as viewed in the rotational axis direction, an edge portion of the frame which forms the opening portion and the pressing roller is separated by a predetermined distance or more.

12. The fixing device according to claim 11, wherein the predetermined distance is an insulation distance determined by a safety standard.

13. The fixing device according to claim 1, further comprising a cover member configured to cover a partial area or a whole area of the opening portion of the frame.

14. The fixing device according to claim 13, wherein a surface, on an opposite side of a surface opposing the opening portion, of the cover member functions as a conveyance guide of the recording material.

15. An image forming apparatus comprising:
an image forming means configured to form a toner image on a recording material; and
a fixing device according to claim 1, the fixing device fixing the toner image formed by the image forming means on the recording material.
